(19) United States
(12) Patent Application Publication
(10) Pub. No.: US 2025/0109997 A1
(43) Pub. Date: Apr. 3, 2025

(54) RESISTIVE SENSING ARRAYS AND METHODS OF MANUFACTURING THE SAME

(71) Applicant: MASSACHUSETTS INSTITUTE OF TECHNOLOGY, Cambridge, MA (US)

(72) Inventors: Michael J. FOSHEY, North Quincy, MA (US); Wojciech MATUSIK, Lexington, MA (US); Yiyue LUO, Cambridge, MA (US)

(21) Appl. No.: 18/729,039

(22) PCT Filed: Mar. 20, 2023
(86) PCT No.: PCT/US2023/015654

§ 371 Date: Jul. 15, 2024

Related U.S. Application Data
(60) Provisional application No. 63/321,760, filed on Mar. 20, 2022.

(51) Int. Cl. G01L 1/20; G06F 3/045

(52) U.S. Cl. CPC G01L 1/205; G06F 3/045; G06F 2203/04103

(57) ABSTRACT

This disclosure relates to new multi-modal sensing array architectures that can sense normal and shear forces. Examples include resistive sensing arrays that are used to measure changes in the environment and manufacturing processes to produce multi-modal sensing arrays in a highly-automated and inexpensive fashion. Specifically, a manufacturing process includes a cutting operation and sewing/embroidery technique that creates a fully automated process to produce a resistive sensing array. The new manufacturing process enables the reduction of processing time and materials to produce a functioning sensor without limiting the designs space of achievable sensor geometries. Also presented are sensor reading methodologies for high-speed reading that are capable of sensing vibrations and a wide range of forces. Examples include the use of the new sensor arrays in wearable devices.

### CROSS-REFERENCE TO RELATED APPLICATIONS

This application claims priority to and the benefit of U.S. Provisional Application Ser. No. 63/321,760, entitled “RESISTIVE SENSING ARRAYS AND METHODS OF MANUFACTURING THE SAME,” and filed Mar. 20, 2022, the content of which is incorporated by reference herein in its entirety.

### FIELD

The present disclosure relates to manufacturing a resistive sensing array, such as arrays that can be used to measure changes in the environment, as well as the resulting arrays from such manufacturing techniques.

### BACKGROUND

Human beings perceive the environment using multiple touch sensory modalities, including pressure, temperature, and vibration. Different modalities complement each other in many ways, which are especially helpful for humans to perform daily activities. For example, when grasping an object, tactile pressure information can help guide whether humans have sufficient grasp, and temperature and vibration sensing information can help humans identify the object and understand whether it is safe to touch or handle. In recent years, new tactile sensing systems have become important tools for providing rich sensory data related to how humans and robots interact with their environments. Recently, using rich data sources, researchers have shown that they can be used to interpret human movement, provide feedback to robots, and remotely monitor systems, which are applications that fundamentally change how humans communicate, conduct commerce, and manage systems. However, currently, many of these tactile sensors are still expensive and time-consuming to manufacture, limiting the commercial application of tactile sensing technology. It is becoming clear that to unlock these important new applications at scale, new manufacturing methods for producing these tactile sensors will be needed to drive down the cost making these sensors.

Recently, a set of prototypes of high-resolution, conformal tactile sensing arrays were developed and manually assembled in configurations spanning from full-body wearables that can be worn by humans and robots, to carpets that can cover large-scale objects. Coupling tactile sensing wearables with tools from the deep learning community, the signatures of human grasps, model the dynamics of hand-object interactions, and identify the human-environment interactions could be learned and discovered. Further, 3D human poses can be estimated from the tactile signal from a sensing carpet. Additional details about these discoveries is provided for in U.S. patent application Ser. No. 17/226,564, entitled “Systems and Methods for Estimating 3D Position and Movement from Tactile Signals.” the contents of which is incorporated by reference herein in its entirety. Much of this foundational work shows that tactile data is a rich source of information about how humans are interacting with their environment. However, these tactile sensing systems are still labor-intensive and time-consuming to produce making it costly to obtain such tactile information in a cost-efficient and scalable manner.

At least some typical sensor arrays include a tactile sensitive layer of material addressed by a network of orthogonal conductive threads on each side. Each individual sensor can be located at the overlapping point between the orthogonal electrodes, which can sandwich a resistive sheet that is sensitive to external environmental changes such as normal forces, temperature changes, vibration, and more. Currently, these sensors are fabricated by hand by placing the set of orthogonal electrodes on each side of the film and manually affixing them. This process is labor-intensive and significantly increases the cost of manufacturing these sensors. Although tactile sensing arrays can be a significant application in emerging technologies, currently the cost of making these sensors limits the scalability.

Accordingly, there is a need for improved techniques for manufacturing resistive sensing arrays, as well as improved sensing arrays themselves, to provide for easier and cheaper manufacturing while maintain or improving performance of such arrays.

### SUMMARY

The present disclosure provides for novel digital manufacturing pipelines that were developed for tactile sensing systems, including but not limited to those discussed herein or otherwise known to those skilled in the art, that would significantly decrease the manufacturing time and cost, making these sensors viable for mass markets. This new manufacturing system is able to automatically layout, as well as manufacture, tactile sensing arrays for arbitrary geometries without human labor input, significantly reducing the cost of the tactile sensing systems and providing for a much more efficient manufacturing process.

One example of the present disclosure is a resistive sensing array that includes a resistive sheet having opposed first and second sides, a first array of electrodes disposed on the first side of the resistive sheet, a second array of electrodes disposed on the second side of the resistive sheet, and at least one passive thread that couples the first array of electrodes to the resistive sheet and couples the second array of electrodes to the resistive sheet, the at least one electrically conductive thread being in contact with each of the first and second arrays of electrodes and passing through the resistive sheet. The first array of electrodes serve as an electrically conductive thread that is a top thread used to couple the first array of electrodes to the resistive sheet while the at least one passive thread serves as a bottom thread used to couple the first array of electrodes to the resistive sheet and the second array of electrodes serve as an electrically conductive thread that is a bottom thread used to couple the second array of electrodes to the resistive sheet while the at least one passive thread serves a top thread used to couple the second array of electrodes to the resistive sheet.

In some examples, the resistive sensing array can include a non-conductive film disposed above at least one of the first and second arrays of electrodes. The first array of electrodes and the second array of electrodes can have a resistance lower than about 1000 ohms per meter. The at least one passive thread can have a resistivity less than or equal to a resistivity of the resistive sheet. In some example, at least one of the first array of electrodes or the second array of electrodes further includes an electrically conductive thread separate and apart from electrodes of the respective first array of electrodes or electrodes of the second array of electrodes.

Another example of the present disclosure is a method of manufacturing a resistive sensing array. The method includes cutting an outline shape of a sensor and one or more internal voids into a resistive sheet and implementing a plurality of lockstitches to couple a first array of electrodes to a first side of the resistive sheet and a second array of electrodes to a second side of the resistive sheet, the first and second sides of the resistive sheet being opposed to each other. In some example, cutting an outline shape of a sensor and one or more internal voids into a resistive sheet provides a resulting shape that includes one or more tabs. The action of cutting can be an automated process. The method can include implementing a plurality of lockstitches further by stitching the first array of electrodes through the resistive sheet such that the first array of electrodes forms a top thread that couples the first array of electrodes to the resistive sheet, stitching a passive thread through the resistive sheet such that the passive thread forms a bottom thread that couples the first array of electrodes to the resistive sheet, stitching the second array of electrodes through the resistive sheet such that the second array of electrodes forms a bottom thread that couples the second array of electrodes to the resistive sheet, and stitching at least one of the passive thread or a second passive thread through the resistive sheet such that the at least one of the passive thread or a second passive thread forms a top thread that couples the second array of electrodes to the resistive sheet.

In some example, implementing a plurality of lockstitches further include placing electrodes from the first array of electrodes and electrodes from the second array of electrodes in successive order. The action of implementing a plurality of lockstitches can be performed using at least one of one or more sewing machines or one or more embroidery machines. In some example, the at least one of one or more sewing machines or one or more embroidery machines are automated. The method can further include installing an electrical connector in electrical communication with at least one of the first array of electrodes or the second array of electrodes. In some example, installing an electrical connector include coupling a backing plate to at least one of the first array of electrodes or the second array of electrodes such that the at least one of the first array of electrodes or the second array of electrodes is disposed between the resistive sheet and the backing plate.

In some examples, the method includes applying a protective insulating coating to the resistive sensing array formed by the resistive sheet, the first array of electrodes, and the second array of electrodes. The method can further include coupling the resistive sensing array formed by the resistive sheet, the first array of electrodes, and the second array of electrodes to one or more additional resistive sensing arrays.

Yet another example of the present disclosure is a force translator system that includes a resistive sheet having opposed first and second sides, a first array of electrodes disposed on the first side of the resistive sheet, a second array of electrodes disposed on the second side of the resistive sheet, one or more groups of force sensors, each group including three or more force sensors and each sensor formed by an intersection of an electrode of the first array and an electrode of the second array, and a plurality of rigid blocks, each rigid block defining a bottom side mechanically coupled with one group of the one or more groups of force sensors and a top side configured to receive a force and direct the force to the one group of sensors. The each rigid block and corresponding one group of force sensors are configured to enable reconstruction of a 3D vector of force applied to the top side of the rigid block based on the force readings from the three or more force sensors mechanically coupled with the rigid block. In some examples, each force sensor of the one or more groups of force sensors are configured to measure force normal to the resistive sheet.

Still another method of the present disclosure is a method of constructing a high-dynamic range tactile sensor map, the method includes reading a first signal at a first gain setting for each of a plurality of resistive force sensors of a tactile sensing array, changing the first gain setting to a second gain setting, reading a second signal at the second gain setting for each of the plurality of resistive force sensors of the tactile sensing array, and combining the first and second signals to generate a map of the tactile sensing array, the map including a single value for each of the plurality of resistive force sensors of a tactile sensing array, the single value being based on a value of the first and second signal for each the plurality of resistive force sensors with respect to a calibration curve such that the single value defines an accuracy at least as high as the highest of the first and second signals. In some examples, the calibration curve defines an accuracy of a value of each resistive force sensors at least with respect to a magnitude of the first and second signal.

### BRIEF DESCRIPTION OF DRAWINGS

This disclosure will be more fully understood from the following detailed description taken in conjunction with the accompanying drawings, in which:

FIG. 1 is a schematic, partially perspective view of a multi-modal tactile sensing array configured to measure normal and shear forces and vibration;

FIG. 1B is a schematic perspective view of a single force translator with a translucent block and corresponding piezoresistive sensor arrangement of the sensing array of FIG. 1A;

FIG. 2A is a schematic top view of an example embroidered tactile sensor array;

FIG. 2B is a schematic cross-sectional view of the sensor array of FIG. 2A;

FIGS. 3A-3F are schematic top views of steps of creating a force sensitive tactile sensing array using an embroidery machine;

FIG. 4A is a schematic top partially translucent view of the electrical connection of one set of electrodes of a sensor array;

FIG. 4B is a schematic cross-sectional view of the electrical connection of FIG. 4A;

FIGS. 5A-5D are schematic sequential views of a process for creating an embroidery file for a shoe insole tactile sensor;

FIG. 6A is a schematic top view of a single scalable tiled resistive sensing array;

FIG. 6B is a schematic top view of a large scale tiled resistive sensing array assembly using a plurality of the arrays of FIG. 6A;

FIG. 7A is schematic top view of an example sensor array design;

FIG. 7B is schematic view of a set of manufacturing instructions for creating the sensor array design of FIG. 7A;

FIG. 8 is a diagram of example readouts from a four-sensor force translator with associated force directions;

FIG. 9A is a schematic perspective view of a four-sensor force translator example with a force applied at an angle to a partially translucent rigid block;

FIGS. 9B-9F are graphs of the four sensor readouts for five direct force directions applied to the force translator of FIG. 9A;

FIG. 10 is a photograph providing a perspective view of an example insole sensor array;

FIG. 11 is a photograph providing a perspective view of multi-modal tactile sensors attached to parallel grippers;

FIG. 12A is a schematic side view of an example piezoresistive sensor;

FIG. 12B is a graph of an example response curve from a piezoresistive sensor when a force is applied;

FIG. 12C is a schematic electrical diagram of an example reading circuit for reading the piezoresistive sensor of FIG. 12A;

FIG. 13A is a schematic top view of an arrangement for reading a sensor of a sensor array;

FIG. 13B is a schematic top view example of a 3 by 3 piezoresistive sensor array segment of the sensor array of FIG. 13A;

FIG. 13C is an equivalent circuit diagram of the array segment of FIG. 13B;

FIG. 13D is a schematic circuit diagram of an example high-speed read-out circuit for the example sensor array of FIG. 13A;

FIG. 14 is a flowchart diagram of an example high dynamic range sensing operation; and

FIG. 15 is a block diagram of one exemplary embodiment of a computer system for use in conjunction with the present disclosure.

### DETAILED DESCRIPTION

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present disclosure is defined solely by the claims. The features illustrated or described in connection with one exemplary embodiment may be combined with the features of other embodiments. Such modifications and variations are intended to be included within the scope of the present disclosure.

The figures provided herein are not necessarily to scale. Still further, to the extent arrows are used to describe a direction of movement, these arrows are illustrative and in no way limit the direction the respective component can or should be moved. A person skilled in the art will recognize other ways and directions for creating the desired result in view of the present disclosure. Additionally, a number of terms may be used throughout the disclosure interchangeably but will be understood by a person skilled in the art.

To the extent the present disclosure includes various terms for components and/or processes of the disclosed devices, systems, methods, and the like, one skilled in the art, in view of the claims, present disclosure, and knowledge of the skilled person, will understand such terms are merely examples of such components and/or processes, and other components, designs, processes, and/or actions are possible.

Articles “a” and “an” are used herein to refer to one or to more than one (i.e., at least one) of the grammatical object of the article. By way of example, “an element” means at least one element and can include more than one element. “About” is used to provide flexibility to a numerical range endpoint by providing that a given value may be “slightly above” or “slightly below” the endpoint without affecting the desired result. The use herein of the terms “including,” “comprising,” or “having,” and variations thereof, is meant to encompass the elements listed thereafter and equivalents thereof as well as additional elements. As used herein, “and/or” refers to and encompasses any and all possible combinations of one or more of the associated listed items, as well as the lack of combinations where interpreted in the alternative (“or”). Moreover, the present disclosure also contemplates that in some embodiments, any feature or combination of features set forth herein can be excluded or omitted. To illustrate, if the specification states that a system or device comprises components A, B and C, it is specifically intended that any of A, B, or C, or any combination thereof, can be omitted and disclaimed singularly or in any combination, including but not necessarily with other components (e.g., D, E, etc.).

Recitation of ranges of values herein are merely intended to serve as a shorthand method of referring individually to each separate value falling within the range, unless otherwise indicated herein, and each separate value is incorporated into the specification as if it were individually recited herein. For example, if a concentration range is stated as 1% to 50%, it is intended that values such as 2% to 40%, 10% to 30%, or 1% to 3%, etc., are expressly enumerated in this specification. These are only examples of what is specifically intended, and all possible combinations of numerical values between and including the lowest value and the highest value enumerated are to be considered to be expressly stated in this disclosure. Unless otherwise defined, all technical terms used herein have the same meaning as commonly understood by one of ordinary skill in the art to which this disclosure belongs.

Humans possess a peripheral nervous system that gives them the ability to sense and interpret tactile information, normal and shear force, and vibrations. This provides humans the ability to perceive changes in our surroundings and react to them, allowing us to complete complex tasks. Bestowing these sensory modalities to robotic systems can enable them to complete complex manipulation and assembly tasks that are trivial for humans. Aspects of the present disclosure provide for new types of robotic skins, examples of which can give robots the ability to sense normal force, shear force, and vibration. Examples can be fabricated with a highly-automated manufacturing process, thus example sensing systems can be inexpensively manufactured. Furthermore, examples can capture forces over a high range by employing multi-gain capturing techniques. Implementations disclosed here demonstrate sensing systems capabilities that can be designed and fabricated for a set of devices and examples include methods of utilizing example devices for human wearables and robotics applications.

The present disclosure presents examples of tactile sensing systems that can integrate a sensor design capable of normal force, shear force, and vibration detection while still being able to be easily integrated into current robotics designs and wearable applications. To make this possible, examples include the use of machine embroidery, a textile process that allows the fabrication of thin piezoresistive sensing arrays in an automated fashion. Further, examples include the incorporation of force translators on top of embroidered tactile sensing arrays that enables the sensing of the directionality of an applied force. Specific examples are presented herein that include a method of reading the sensor to enable sensing vibrations up to about 500 Hz and reading forces approximately in the range of about 0.5 N to about 6 N. Finally, examples of the present disclosure include calibration techniques that enable calibration of example tactile sensing systems' force readings in an automated manner. Examples are shown herein that include example sensing systems for use in robotics and wearable device applications alike.

A number of different sensing devices, arrangements, and systems are presented herein. Examples include tactile sensing, piezoresistive sensors, capacitive sensors, and optical sensors. An introduction to each of those systems is presented below.

Piezoresistive Sensors: The piezoresistive effect occurs when a material changes its electrical resistance when a force is applied to it and mechanically deforms. Materials such as force-sensitive polymers, rubbers, and foams can exhibit this phenomenon. These example materials can be mixtures of material that makes up a structural matrix and a conductive polymer that is dispersed about that matrix. As the matrix is compressed, the conductive particle gets closer together and creates conductive traces in the material.

Capacitive Sensors: Capacitive sensors typically include two conductive plates that are separated by a deformable material that keeps the two plates electrically separated. When pressure is applied to the sensor during operation, the deformable layer deforms and brings the two plates closer together, changing the sensor's capacitance. One advantage is that capacitive sensors can be read at a very high frequency compared to other technologies.

Piezoelectric Sensors: Piezoelectric sensors can include materials that generate a charge when a crystalline material deforms. Examples include a quartz and/or lead zirconate titanate material to generate a charge, but less expensive polymers have also been developed and tested.

Optical Sensors: Optical sensors can be arranged to measure changes in a material's optical properties or geometry through the use of an embedded camera system. These systems can be used to estimate the geometry and force applied to an object that is touching the surface by placing spatial trackers on the surface of an optical material, measurement of shear force is possible by using similar optical-based tactile sensors.

### Sensor Design and Manufacturing

### Multi-Modal Tactile Sensing Arrays

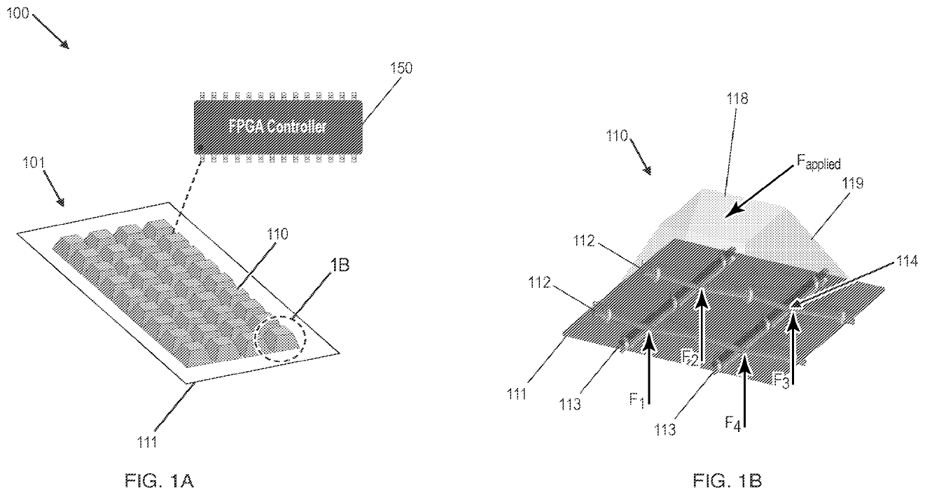

Examples of the present disclosure include a new tactile sensor that is able to sense normal force, shear force, and/or vibrations. FIG. 1A shows an example multi-modal sensing array system 100 that includes a force and vibration sensory assembly 101 and a controller 150 for reading the sensor outputs from the assembly 101. The sensor system 100 can include three main parts: an embroidered force resistor sensor array 111, a force translator 110 disposed above the sensors of the array 111 (with the array 111 and translators 110 together forming the assembly 101), and an FPGA-based sensor reading circuit 150. The embroidered force resistor array 101 can be used to capture information about changes in force on the surface of the sensor. The force translator 110 can be configured to extract the directionality of an applied force. The embroidered force resistive array and force translators can be tiled over the entire area of a desired surface. The FPGA-based sensor reading circuit 150 can be used to capture readings from the sensing assembly 101 at high-speed.

FIG. 1B shows a detail view one force translator 110 with the associated sensors of the sensor array 111. The sensor array 111 includes vertical 113 and horizontal 112 (e.g., orthogonally arranged) electrodes that form individual sensor locations 114 at their intersection. As shown, the force translator includes a rigid body 119 sized and shaped to engage four sensors 114 in a square pattern. In this configuration, which is explained in more detail in other sections of this disclosure, forces applied to the top surface 118 of the body 119 can engage up to all four of the sensors 114 with individually measured forces (F1, F2, F3, and F4, as indicated) that can be used to calculate a vector of the force applied to the body 119. The rigid body 119 also enables vibration forces to be transferred to the sensors 114, thus enabling multi-modal measurements (e.g., normal force, sheer force, vibration) for each force translator arrangement 110. Examples also include sensor arrays 111 without force translators.

Examples of the present disclosure include the manufacturing of example multi-modal tactile sensors by the use of two highly automated manufacturing processes, which are machine embroidery and 3D printing. Utilizing these manufacturing processes can greatly reduce the manual processing needed to make a sensor, reducing that overall cost. Examples include manufacturing a piezoresistive tactile sensor with machine embroidery, and separately manufacturing force translators with an additive printing technique. Thereafter, the method include coupling the piezoresistive tactile sensor with the force translators to create a working sensor.

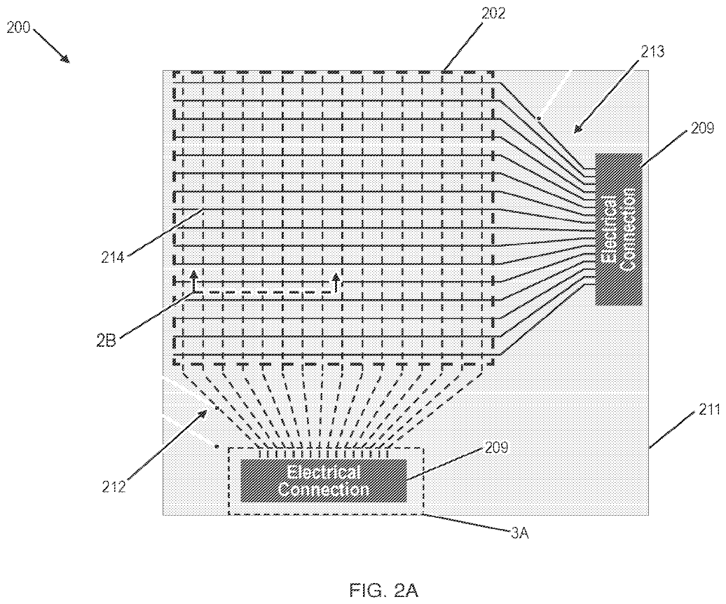

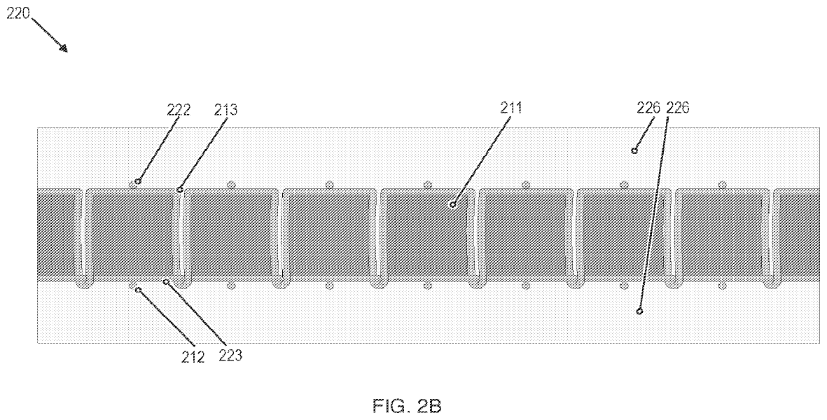

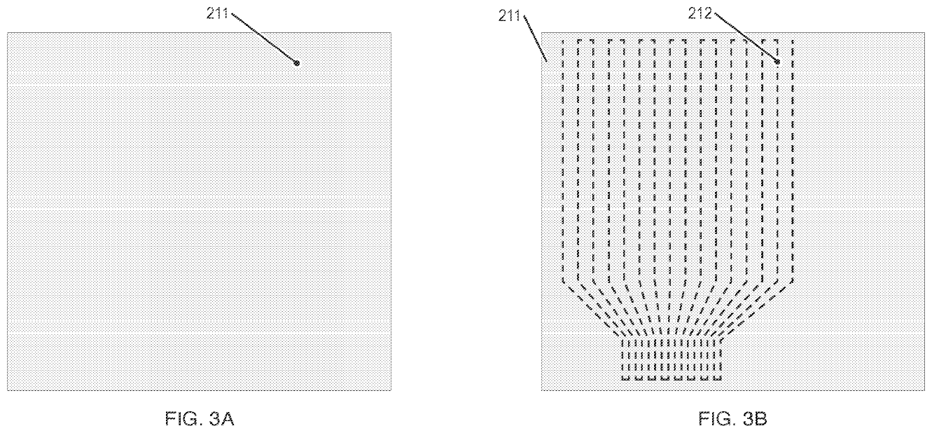

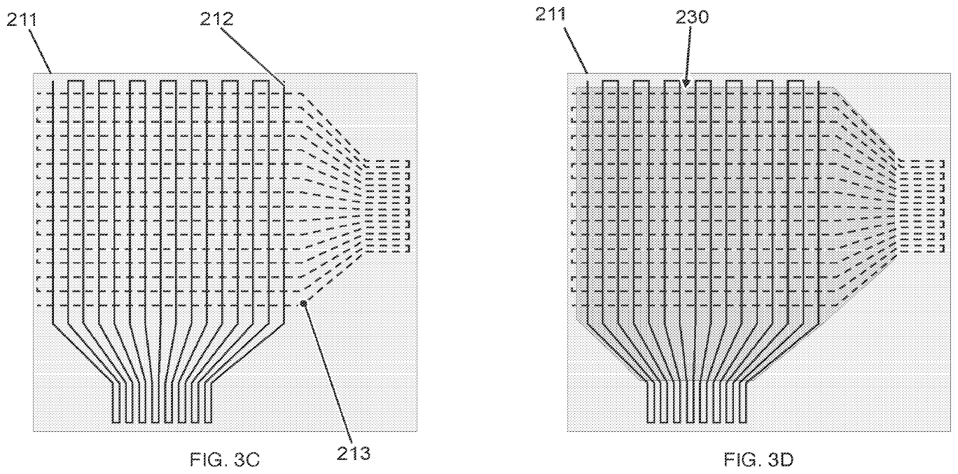

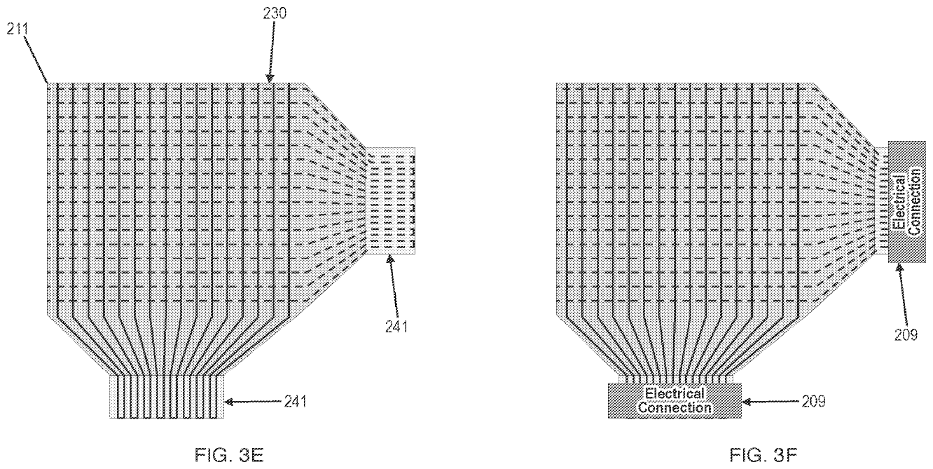

An example resistive sensor array can include a number of different components, including a resistive sheet, an array of electrically conductive threads or filaments located on each side of the sheet, and non-conductive passive threads or filament used to interlock the electrically conductive threads through the sheet and an electrical connector board that interfaces with sensing electronics. In a representative example array 200, shown in FIG. 2A, a resistive sheet 211, electrodes 212, 213, and an interlocking passive thread is then sandwiched by a non-conductive film to protect the sensing array from environmental hazards and shorting. In operation, the electrodes 212, 213 can be used to measure the resistance of the resistive sheet at the specific point 214 where a pair of top and bottom electrodes intersect. In the example of FIG. 2A, the vertical electrodes 212 are on a bottom side of the sheet 211 and the horizontal electrodes 213 are disposed on a top side of the sheet 211. The collection of these intersections 214 forms a sensing region 202. The resistance of the resistive sheet 211 reacts to external environmental changes such as force, temperature, vibration, chemical, or summation of two or more of these sensing modalities. The electrodes 212, 213 can be arranged to sense the resistance change at various locations on the resistive sheet and creates an electrical connection to a set of connection points 209 that interface with sensing electronics (more details about this connection are shown in FIG. 3A). To place the electrodes 212, 213, a series of sewing switches can be used to affix the electrode to the resistive sheet, as shown in FIG. 2B, which is a cross-sectional view of the array 200 taken at location 2B in FIG. 2A. During the stitching process, each electrode 212, 213 can be interlocked with a thread that is resistive or non-conductive. In FIG. 2B, each vertical electrode 212 can travel in parallel with a passive thread 222 opposite the sheet 211 and each horizontal electrode 213 can also pass in parallel with a passive thread 223 opposite the sheet 211. In some examples, an insulating layer 226 can be applied above and/or below the sheet 211 and electrodes 212, 213.

Examples of embroidered sensors presented herein have two primary functional components, the resistive sheet and the conductive electrodes. The resistive sheet can act as a force-sensitive resistor where the resistance between the top and bottom of the sheet changes when a force is applied to the sheet. Example embroidered sensors can utilize a volume-conductive carbon-impregnated polyolefin sheet of thickness of 6 mils (e.g., Velostat by Desco in Canton, MA). Examples also include resistive sheets stacked to increase resistance. The conductive electrodes can create electrical traces that measure the resistance at a specific point of the resistive sheet. Examples include a silver-plated polyamide thread as a conductive electrode (e.g., HC40 by Madeira in Freiburg, Germany).

Example resistive sheets can be made of any material, such as a material that is sewable and has piezoresistive properties. The piezoresistive sheet can also be a woven or knitted fabric. Example electrode materials include materials that are both conductive and flexible enough to sew with can be used as electrode materials. These include other types of threads, such as HC40, which is polymer-based and coated is in a conductive material. In addition, the thread can constructed with a conductive material, such as stainless steel or carbon fiber. The thread can be can also be made of one or more filaments. The upper and lower electrodes can also cross from any angle from about 5 degrees, up to about 90 degrees. Examples include two sets of electrodes only intersecting at one point on the sheet.

### Manufacturing Process Examples

The manufacturing process of the resistive array sensors can include, but is not limited to, actions such as a cutting step, a stitching step, a step where the electrical connection is installed, and a coating step where an insulative coating is applied. Alternatives to these steps may also be provided for herein, and other alternatives can be understood by a person skilled in the art in view of the present disclosures. A brief overview of a manufacturing process includes the following four steps: (1) cutting the outline of the array in a resistive sheet; (2) affixing electrodes to the resistive sheet (e.g., by lockstitching); (3) creating electrical connections to the electrodes; and (4) applying an insulating coating around the array. Examples of manufacturing tactile sensing arrays also include using machine embroidery to automate the placement and affixing of electrodes to the resistive sheet. Although previous architectures of force resistive sensing arrays require inexpensive materials, typically they require manual placement of the electrodes in the correct location, which significantly increases the total cost of the sensor and reduces the ease of scalability. By using an automated process to lay the electrodes, aspects of the present disclosure greatly decrease the total cost of our sensors.

In cutting of the outline of the array in a resistive sheet, the outline shape of the sensor, as well as any internal voids, can be cut into the resistive sheet using a manual and/or automated cutting process. Any cutting process that sufficiently cuts the resistive sheet may be used, such as cutting with a laser, cutting blade, and/or stamping. During the first cutting process, a set of tabs can be left to hold the final resistive sensor array in place within the monolithic resistive sheet to hold the sensor in-place during the proceeding manufacturing steps.

After the cutting step, a stitching process can be performed on the previously cut resistive film where, during this step, the electrodes can be affixed onto the resistive sheet, for instance via a series of lockstitches. A set of electrodes can be affixed to opposite sides of the resistive sheet. To do this, either a manual or automated sewing/embroidery machine can be used to locate the stitching head at each consecutive stitching location and create each lockstitch. While affixing the electrodes to the top surface of the resistive sheet, the electrode can be used as the top thread, and the passive thread can be used as the bottom thread. While affixing the electrodes to the bottom surface of the resistive sheet, the electrode can be used as the bottom thread and the passive thread can be used as the top thread. Electrodes can be placed on each side of the resistive sheet in successive order.

The stitching process can be performed using machine embroidery, which is a textile manufacturing technique that sews threads onto textiles to create patterns. An example embroidery machine is comprised of two main parts: a motor-driven stage that moves a sheet in x and y directions; and a sewing head that can affix thread to the sheet using a lockstitch. During operation, the embroidery machine's stage can move to a set of points that lie on a prescribed path. At each point, the sewing head can create a lockstitch affixing a thread to the sheet. As the embroidery machine continues to affix the thread, it can lay a line of thread along the prescribed path, creating a pattern. FIGS. 3A-3F show example steps for manufacturing an example sensing array. Examples of manufacturing tactile sensors include using an embroidery machine to affix the electrodes to a resistive sheet. In a first step, shown in FIG. 3A, a resistive sheet 211 can be installed into an x-y stage of an embroidery machine. The embroidery machine can use a passive thread as the top thread and conductive thread as the bobbin thread. Next, in FIG. 3B the embroidery machine can follow a prescribed path to affix one electrode 212 to the resistive sheet 211. For ease of manufacturing, the set of electrodes can be connected together into one serpentine pattern to reduce the number of times the embroidery machine must start and stop a thread. After one side of the resistive sheet is populated with electrodes, the entire sheet can be flipped, and the same electrode-laying process can then be completed on the opposite site, as shown in FIG. 3C, with the second electrode 213 having been threaded on the sheet 211. Next, as shown in FIG. 3D, one or more insulating sheet 230 can be sewn in needed places to protect the electrodes from electrically shorting. Finally, with the sheet 211 cut to leave only the portions with electrodes remaining, as shown in FIG. 3E, the ends 241 of the electrodes 212, 213 can have electrical connectors attached, as shown in FIG. 3F, to interface with a device for reading the sensor array.

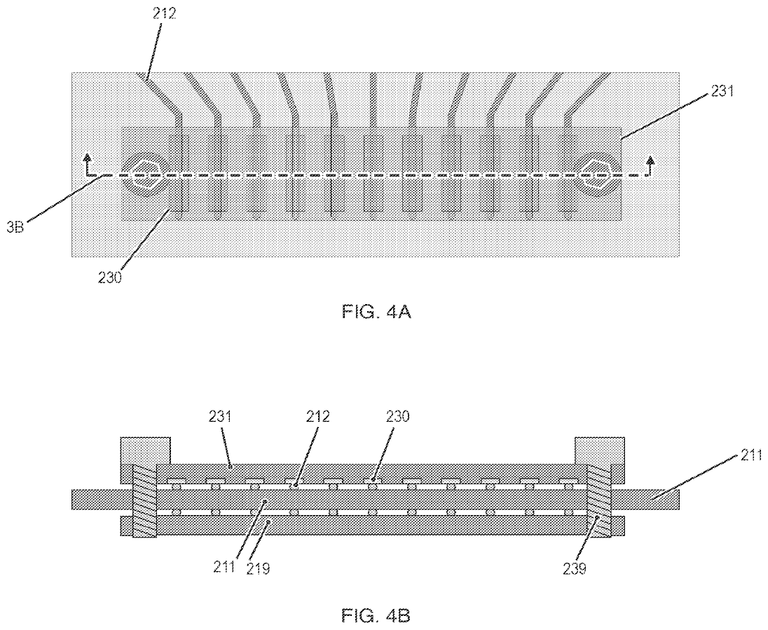

To affix the device, and as shown in FIGS. 4A and 4B, the electrodes 213 can be clamped in between a printed circuit connector 231 and backing plate 219 creating a mechanical and electrical connection between the electrodes 212 and connector contact pads 230. The pitch of the electrodes 212 on the resistive array 211 and contact pads 230 on the printed circuit connector 231 can be matched, and a large enough pitch can be used to ensure no shorting between electrodes 212. The printed circuit board 231 can be clamped to the resistive sensing array (e.g., sheet 211 and electrodes 211) with enough force to ensure no movement between the printed circuit connector 231, resistive sheet 211, and electrodes 212. This step can be performed before or after the final cutting procedure. During the final cutting procedure, the sensing array can be removed by cutting the tab and threads that hold the sensing array to the surrounding sacrificial resistive sheet. Finally, a protective insulating film can be applied to the resistive sensor array to ensure no electrical shorting or damage from the environment.

### Sensor Layout

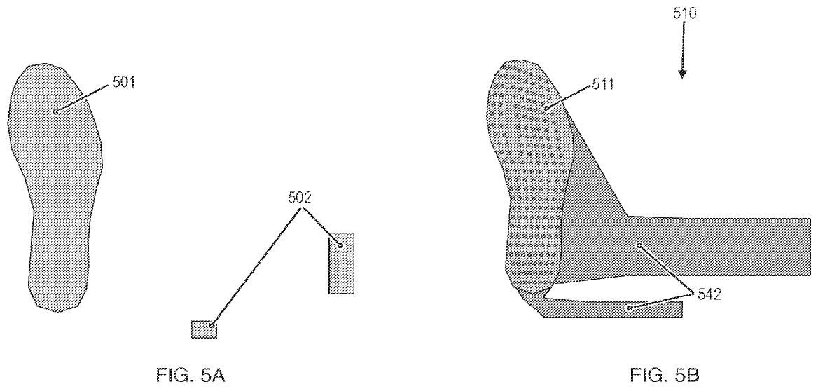

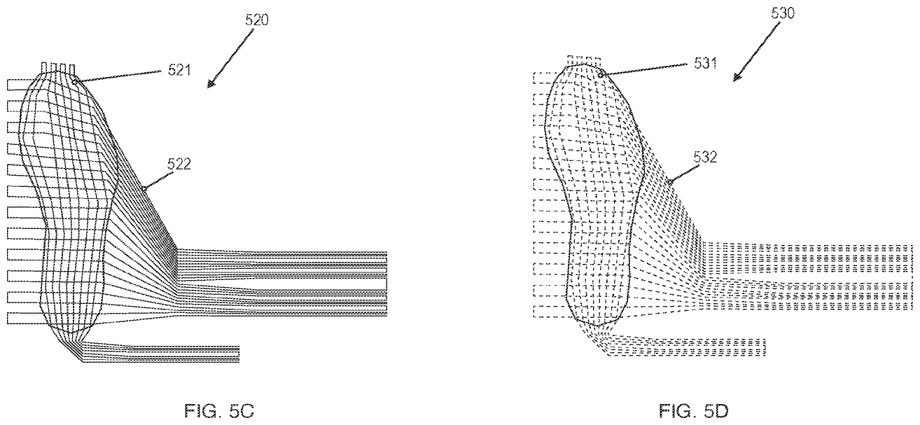

A sequential list of locations to create stitches can be provided to program an automated embroidery machine. To achieve this, a sensing area 501 geometry and the location of the electrical connectors 502 with respect to the sensing area 501 can be defined, as shown in FIG. 5A. Other parameters, such as the number of sensors and density, can be predetermined before laying out the electrodes. As shown in FIG. 5B, with the sensing area 501 defined, individual sensing locations 511 and electrode routing areas 542 can be established. Once these parameters are selected, and the sensing area and connector location are known, the sensor locations and the electrode routing area can be determined, and the two vector paths can be laid out within those areas, as shown in FIG. 5C. Once the sensor locations 511 are defined, top 521 (e.g., vertical) and bottom 522 (e.g., horizontal) electrodes vector paths can be planned to orthogonally cross, creating each sensor location. Next, as shown in FIG. 5D, each vector path 521, 522 can be converted into an array of equidistant points 531, 532 that lie along each vector path 521, 522. To avoid shorts, points can also be chosen to be a specified distance from the opposite electrode path. Finally, the set of points 531, 532 can be converted into a file format that can be interpreted by an automated embroidery machine. Separate embroidery files can also be created in a similar fashion to affix the insulating fabric to the sensing arrays to protect against shorting.

### Large Resistive Sensor Arrays

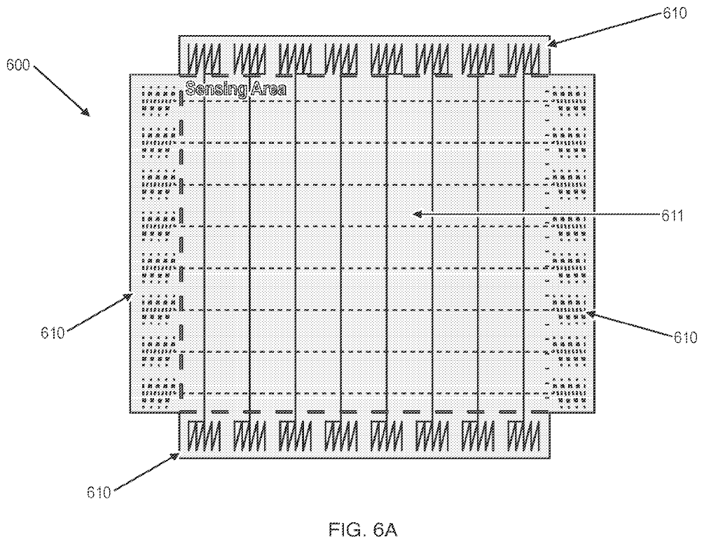

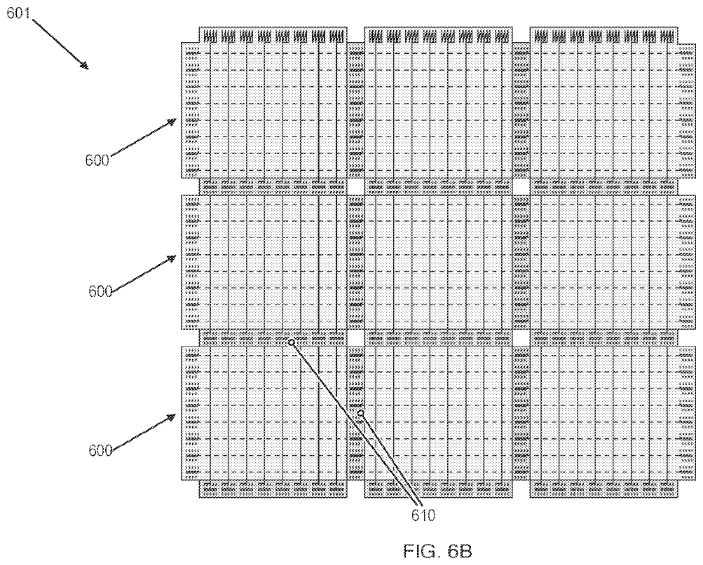

For some applications, sensor arrays may need to be made to cover large areas. However, sewing/embroidery equipment can have a limited area that can be created with stitches within. To circumvent this size limitation, examples of the present disclosure include designs that comprise a set of tiled sensor arrays such that each tile fits within the stitching area of the sewing/embroidery equipment. Using a number of tiles, the arrays can then be assembled into a one large sensing array that is much larger than the stitching area of the manufacturing equipment used. As shown in FIG. 6A, a tileable sensor array tile 600 can include a sensing area 611 as well as a set of connecting patches 610 on each edge of the tile 600. These tiles 600 can be manufactured using the processes described herein or otherwise useable by those skilled in the art in view of the present disclosures. After manufacturing, and as shown in FIG. 6B, the tiles 600 can be assembled into a larger tile assembly 601 by overlapping the connecting patches 610 of each tile 600 to make an electrical connection between each tile 600. The adjacent tiles 600 can be affixed to each other using, for example, conventional sewing techniques, clamping, and/or gluing.

### Generation of Manufacturing Instructions

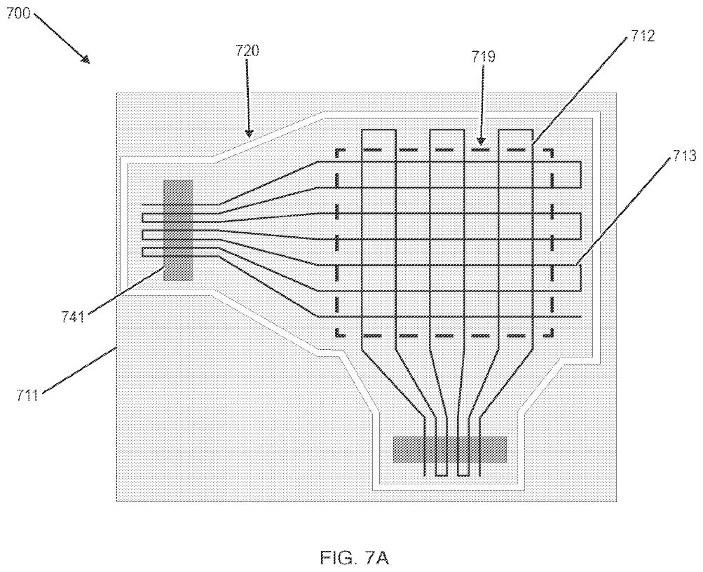

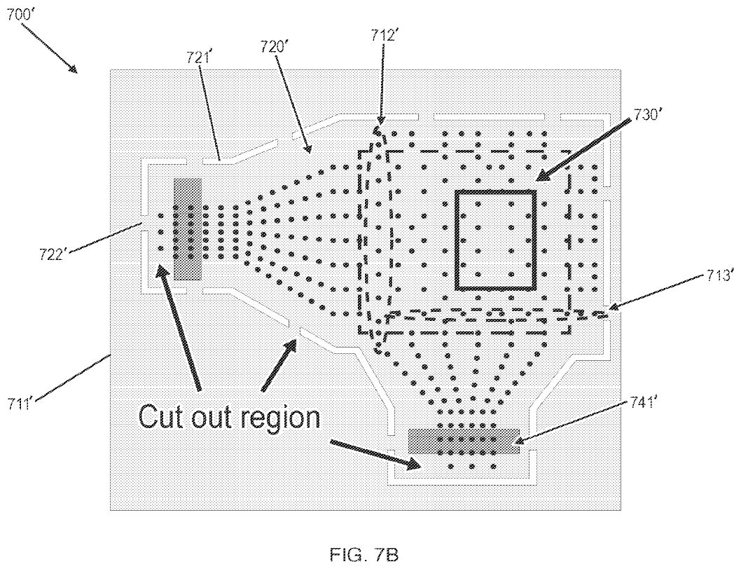

Examples provided for herein include the generation of manufacturing instructions. The instructions can, for instance, define the placement of top and bottom electrodes of a sensor array and/or define where to cut the resistive sheet. Examples include starting with a set of inputs about a desired sensing shape and location, sensor modality and sensitivity, and/or locations of electrical connections. An example sensor design 700 is shown in FIG. 7A, and the resulting example manufacturing instructions 700′ are visually represented in FIG. 7B.

In FIG. 7A, an outline shape 720 and the location of the sensor region 719, including individual sensor locations (e.g., intersections between vertical 712 and horizontal 713 electrodes) can be defined, which can later be provided as an output as a set of cutting paths for the cutting processes disclosed herein. The locations 741 of the circuit connections can be established as well. To create the cutting paths, an algorithm can trace outlines of the sensor shape 719, as well as create an outline around any other electrodes 712, 713. As shown in the manufacturing instructions 700′ of FIG. 7B, tabs 722′ can be created along the cutting outline instructions 722′ by adding gaps in the cut to keep the sensor material 720′ connected to the surrounding resistive sheet 711′. Afterwards, an arrangement of both the top and bottom electrodes 712, 713 can be defined to attain the desired sensor shape and characteristics. The sets of electrodes 712, 713 from the design 700 can be defined in the instructions 700′ as two separate paths where stitches 712′, 713′ are placed along that path, each path originating at a connection location 741′. Stitches 712′, 713′ can be placed evenly along the stitch path separated by a distance equally to the stitch length. During the stitch layout process, stitches that are too close to other stitches in the other electrodes can be moved or removed (e.g., in box 730′ of FIG. 7B) to avoid the shorting among the top and bottom electrodes. Lastly, the individual paths of the top and bottom electrodes can be converted into the corresponding embroidery machine instructions that can be interpreted by the embroidery machine. Examples of the manufacturing instruction generation procedure can be used to create outputs that are usable for the manufacture of sensor arrays of the present disclosure.

Aspects of the present disclosure include how lockstitches are positioned and/or used with respect to each other, as well as the order in which the threads are used to couple the electrodes to the resistive sheet. As disclosed above, two threads can be provided-one that is conductive and one that is passive. The use of a passive thread generally provides for an insulative layer, but it was unexpected that the use of passive thread did not negatively affect the electrical conductivity performance of the sensing array.

The present disclosure can be used in conjunction with manufacturing various textiles, among other objects, including but not limited to carpets, sensing wearables, and the like disclosed in U.S. patent application Ser. No. 17/226,564, entitled “Systems and Methods for Estimating 3D Position and Movement from Tactile Signals.” the contents of which is incorporated by reference herein in its entirety. Notably, while U.S. patent application Ser. No. 17/226,564 focused more on manufacturing by way of knitting, the present disclosure uses an embroidery process, which provides for higher resolution and faster manufacturing, among other benefits. The term embroidery, as used in the present disclosure, relates to using a stitching process. The stitching processes of the present disclosure are used functionally, but can also have an artistic contribution to the overall construction if desired.

### Example Force Translators

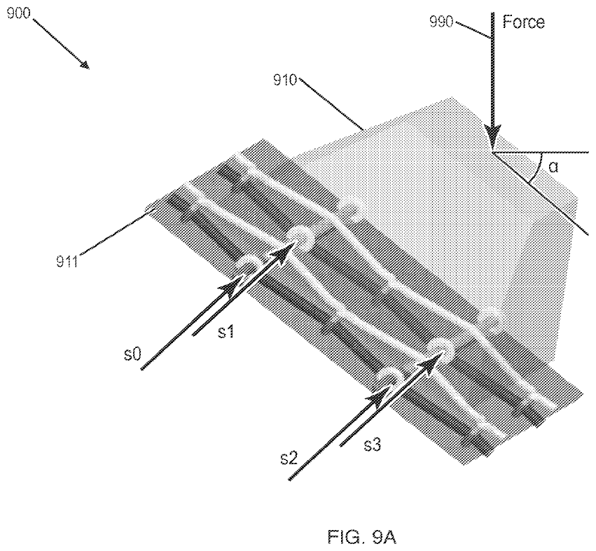

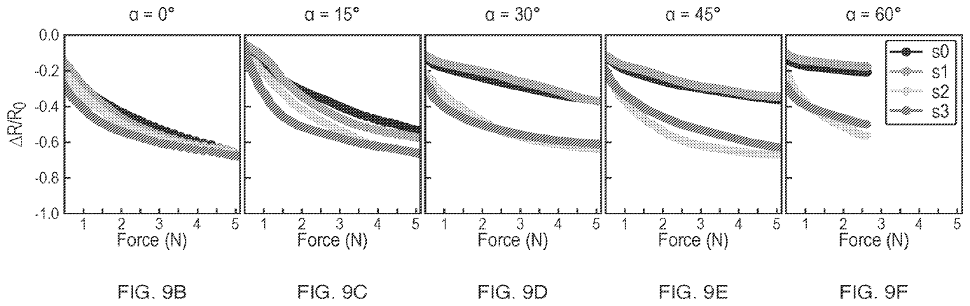

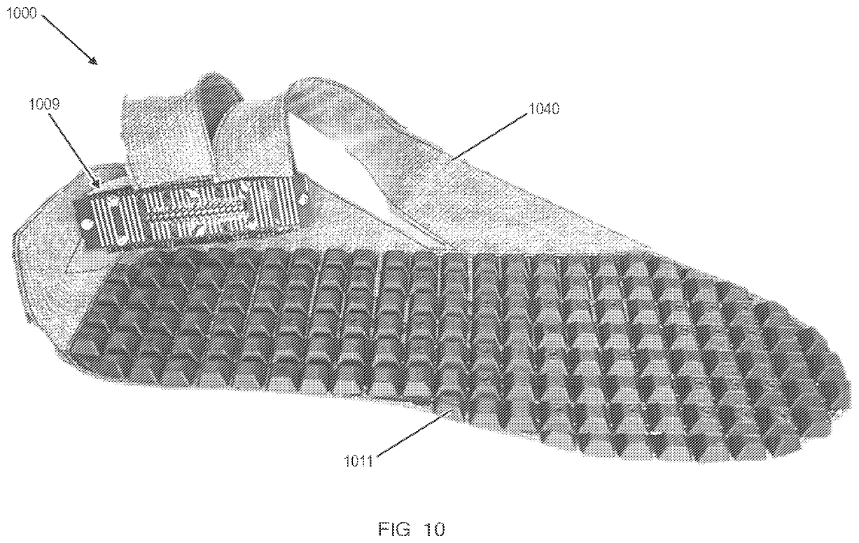

Another example of the present disclosure are force translator arrangements, such as the example for translator 110 shown in FIG. 1B. Such arrangements can include, generally, two or more force sensors 114 arranged under a rigid structure 119 that can be configured to direct forces for a contact surface 118 (e.g., the top of the structure) of the rigid structure 119 to the force sensors 114 disposed below. In operation, when three or more sensors are used, a force vector applied to the contact surface generates a force profile for the three or more force sensors that can be used to reconstruct the force vector based on the read-outs from the force sensors. When only two force sensors are used, a degree of freedom for the reconstruction may be lost. At least some of the systems illustrated herein show four force sensors being used, which enable robust 3D force vector reconstruction, as well as ease of manufacture due to the sensor grid being simplest to construct as an orthogonal X by Y array (as shown throughout). Example force translators can extract force direction information from the normal force reading that embroidered tactile sensing array examples of the present disclosure can measure. In the Example of FIGS. 1A and 1B, a set of rigid blocks 119 is affixed to the top of a tactile sensing array, with four sensors 114 disposed below each block 119. This arrangement is also shown in the example of FIG. 9A, discussed in greater detail below. During operation of a force translator, a force vector of (as indicated by ‘F_{applied}’ in FIG. 1B) is applied to the top (e.g., contact surface 118) of the force translator 110. The three components of the vector (e.g., Fₓ, F_{y}, F_{z}) can be computed from the readings from the four sensors 114 below the force translator block 119. To obtain the normal force F_{z} the readings from all four sensors can be summed. To obtain the x and y force components, the difference between the left and right, as well as top and down sensors can be taken. A geometric correction factor can then applied to adjust for the size and thickness of the force translator. The matrix form of this example calculation is shown in Equation 1:

$$[ \begin{matrix}{F}_{1} \\ {F}_{2} \\ {F}_{3} \\ {F}_{4}\end{matrix} ] [ \begin{matrix}1 & 1 & 1 & 1 \\ 1 & - 1 & 1 & - 1 \\ - 1 & 1 & - 1 & 1\end{matrix} ] = [ \begin{matrix}{F}_{z} \\ {F}_{x} \\ {F}_{y}\end{matrix} ] \qquad ( Equation 1 )$$

The rigid blocks 119 of the force translator 110 can be manufactured using any known materials or techniques, such as with a 3D printer, and the block 119 can have any shape so long as the block rigidly coupled a contact surface to the force sensors 114. The block 119 can have an outer surface that allows the sensor to have grip, such as an elastomeric material. The blocks of FIGS. 1B and 9A are shown to have a pyramidal shape, which can advantageous for directing shear forces to the force sensors without creating excess tension between the block and the sensor array. Calculations of the force vectors described in Equation 1 assume that block 119 of the force translator 110 is sufficiently stiff. Examples includes force translators made from rigid composite materials, such as carbon fiber-impregnated nylon. The size and dimensions of the force translator can be determined by the overall size of the sensor array being fabricated. The force translators can be affixed onto an embroidered tactile sensor by a variety of means know to those skilled in the art, such as with use of double-sided tape.

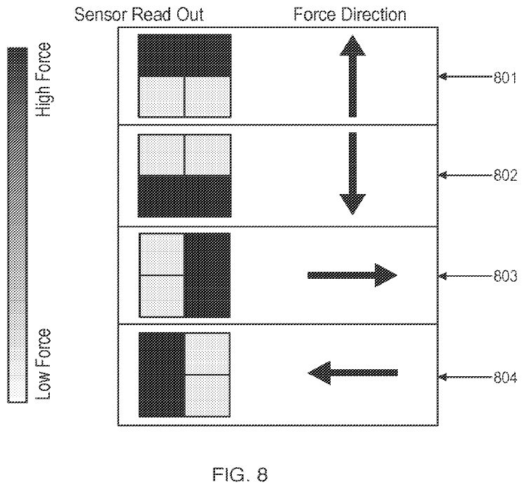

FIG. 8 shows examples of sensor readouts with their corresponding calculated force directions, with respect to the page. An upwards force direction 801 corresponds to increase force on the upper two sensors, as an upper force direction on the force translator primarily directs normal forces (e.g., into the page, as shown) to the top two sensors. Similarly, a downwards force direction 802 primarily loads the bottom two sensors, a right force direction 803 primarily loads the right two sensors, and a left force direction 804 primarily loads the left two sensors. In practice, because the force directions are unlikely to be perfectly aligned with the senor orientations, a mix of positive readouts from 3 or 4 sensors is expected.

While examples of the rigid block of the force translators shown herein are approximately pyramidal in shape, examples include cubic shapes as well as other volumetric configuration. In addition, while the bottom surface of the rigid blocks illustrated herein appear approximately flat, other examples are within the scope of the disclosure, include shapes that match otherwise complement a geometry of the sensors or an object to which the resistive sheet is configured to be attached. For example, if a sensor array is configured to be installed onto a cylindrical object, the bottom surface of the force translator block(s) can have a cylindrical curvature incorporated into the geometry to better interface with the sensors of the array when those sensors conform to the objects curved geometry.

To measure the sensing performance under sheer force of the example force translator 900 of FIG. 9A, an experiment was conducted with sensors attached to the force translator 900 and then mounted on a customized 3D-printed stands at angles of about 15, 30, 45, and 60 degrees. During characterization, a normal force 990 (up to about 6N at the speed of about 2 mm/min) was applied in the middle of the top contact surface of the force translator block 910, which generated both normal and sheer force towards the sensing units s0, s1, s2, and s3. The read-outs from all four sensors are shown in FIGS. 9B-9F for the five different force angles. FIGS. 9B-9F shows that, as the angle alpha increased, the separation between the resistances of s0 and s1 and s2 and s3 increased. The results of FIGS. 9B-9F, in combination with Equation 1, enable reconstruction of the applied force vector 990.

To test the design and fabrication of the example multi-modal tactile sensors, example devices were manufactured for wearable and robotics applications. For wearable device applications, a tactile sensing insole was developed, made, and tested, with a form factor that is capable of being worn within a shoe while a user is standing and walking. A photograph of the example wearable insole is shown in FIG. 10. The example wearable insoles 1000 were designed to measure the normal and sheer force that a human applies while they stand and walk. The sensor array includes 48 (4×12) multi-modal sensors. The sensors are spread over an area of about 55 mm by about 280 mm. To design the sensor, the sensor locations were first laid our within the area of an insole that fits within a target shoe. Next, an embroidery file was created that would place the electrodes in the proper location. Finally, a set of force translators was designed that cover the entire area of the insole. The insole 1000 includes a force translator array 1011 with a sensor array (not visible) underneath. The insole 1000 includes an electrical connection 1009 that enables connection and read-out from the sensor array via the embroidered electrodes 1040 that extend therefrom.

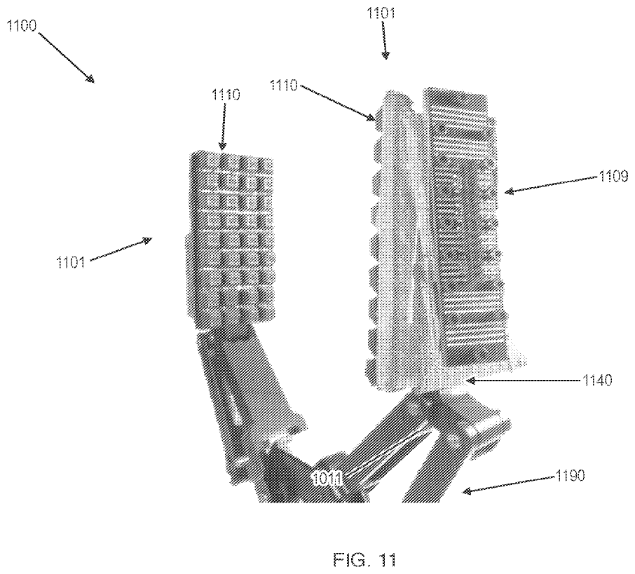

Furthermore, for a robotics application, tactile sensing grippers for a robotic hand were developed, made, and tested. A photograph of the example tactile sensing grippers is shown in FIG. 11. The tactile sensing grippers 1100 includes opposing moveable arms 1101 of a robotic gripper joint 1190, with each arm having a tactile sensing gripper 1110 (e.g., force translator array) with sensor arrays underneath disclosed thereon. Each tactile sensing gripper 1110 includes an electrical connection 1109 that enables connection and read-out from the sensor array via the embroidered electrodes 1140 that extend therefrom. The set of robotic grippers 1100 were designed to measure the normal and sheer force when a robot grasps and interacts with objects. Two multi-modal tactile sensors were designed, manufactured, and then attached to each jaw on a parallel gripper. Each gripper is about 48 mm by about 108 mm and has 36 (4×9) multi-modal sensors on its surface. The sensor was laid out to attain the desired sensor density, and the electrodes were routed to connection points on the back of each gripper.

### Example Sensor Reading Methodologies

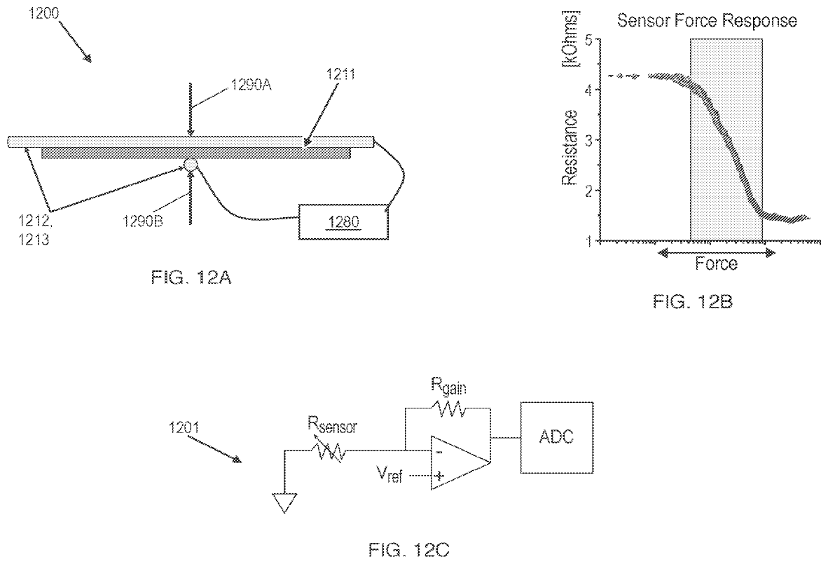

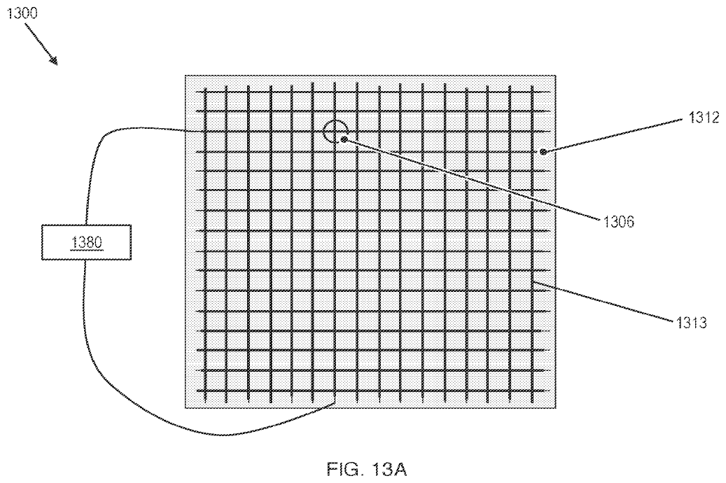

One example of the present disclosure are multi-modal tactile sensors that include a piezoresistive-based sensor array, which indicates that the resistivity of each sensor changes when the applied force changes on that sensor. An example piezoresistive-based sensor is shown in arrangement as shown in FIG. 12A. Each sensor 1200 can be comprised of a force-sensitive film 1211 and two orthogonal electrodes 1212, 1213. In operation, when a force (as indicated by arrows 1290A, 1290B) is applied to the film 1211 a resistance 1280 between the two electrodes 1212, 1213 changes. This resistance measurement can then be correlated to a known force as shown in the force vs. resistance graph of FIG. 12B for an example of the sensor 1200 of FIG. 12A.

To take a reading of this resistance, a non-inverting operational amplifier circuit can be used. An example of this circuit 1201 is shown in FIG. 12C. The circuit 1201 uses an operational amplifier with a reference voltage supplied to the positive input of the op-amp. A force-sensitive resistor can be connected between the negative input of the op-amp and ground. A gain resistor is attached between the op-amp's output and the negative input and can be changed to adjust the sensitivity of the reading circuit. The voltage is then measured at the output of the op-amp to read the change in the resistance of the force-sensitive resistor.

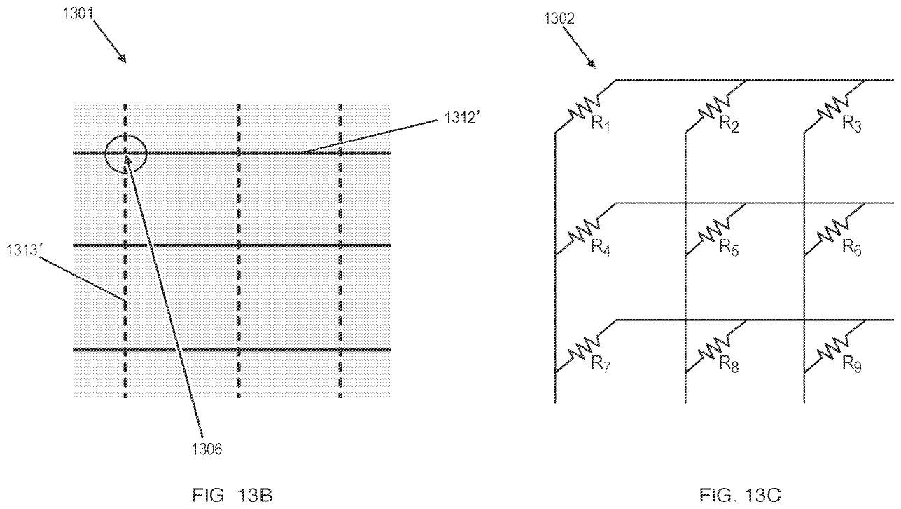

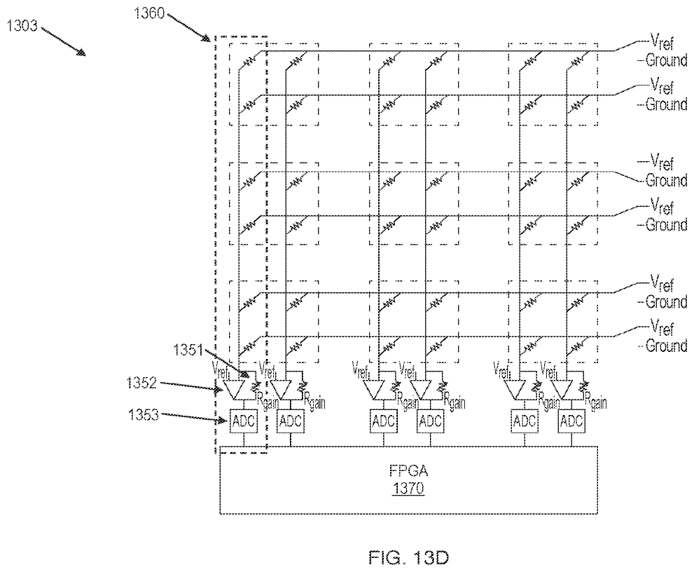

To create an array 1301 of these piezoresistive-based sensors, a set of horizontal 1312 and vertical 1313 electrodes can be created, as shown in 13A. In the example array 1300 of FIG. 13A, the sets of electrodes 1312, 1313 run parallel to each other. To take a reading of one sensor 1306, a pair of horizontal and vertical electrodes 1312′, 1313′ that cross at a desired location 1306 can be selected, as shown in the subset 1301 of the array 1300 in FIG. 13B. However, due to many other vertical and horizontal electrodes crossing paths with the selected set of electrodes 1312′, 1313′, the resistance reading may include a large number of parallel resistance readings of other sensors, as shown in FIG. 13C. In FIG. 13C, a resistor array 1302 representation of the sensor array segment 1301 of FIG. 13B is shown. The resistor array 1302 includes nine resistors, with R1 being the resistance of interest (e.g., corresponding to sensor 1306). The other paths where current can flow can cause an error in the reading of the resistance of interest. To mitigate the error, isolation of the parallel resistances from the sensor resistance of interest can be done to reduce the amount of cross-talk current. Examples of the parallel resistances in FIG. 13B are R4+R5+R2 and R7+R9+R3.

Examples can include the use of an isolation circuit (e.g., as proposed by Shimojo et al.) to mitigate the amount of cross-talk current and only take a reading of the resistance of the one sensor of interest. Example isolation circuits can utilizes a set of two-way switches attached to each horizontal electrode. Thus, when one horizontal electrode is used for the reading of a resistor, the switch for that row can be set to ground and all other rows are set to the reference voltage. This arrangement enables only the current from the reading circuit to flow through the resistor of interest and thereby isolating the resistor of interest from all the parallel resistances that cause the error.

### High-Speed Readout Circuits

Example implementations of the present sensor arrays can be based on a flash programmable gain array (FPGA), (e.g., the Kria KR260 by Xilinx in San Jose, CA, USA). An illustrative example implementation is shown in FIG. 13C. In FIG. 13D, a high-speed read-out circuit 1303 includes a plurality of sensor columns 1360, with each each column in the signal array 1303 having a digital potentiometer 1351 to set the gain of the signal, an op-amp 1352 for signal conditioning, and an analog-to-digital controller (ADC) 1353. The signals controlling digital potentiometers and ADCs can be implemented using a programmable logic (PL) part of an FPGA 1370. For each readout, the value of the digital potentiometers can be set, a specific row can be selected, and the ADC output of all columns can be read simultaneously. Thereafter, another row can be selected and the read operation repeated until the entire array is sample. The data from ADCs can be sent to a direct memory access (DMA) controller using an interconnect infrastructure, such as AXI-stream for the Xilinx system. Moreover, while examples shown herein include certain FPGAs, ADCs, and op-amps, these are representative and one skilled in the art will appreciate that these specific components can be replaced by functionally equivalent parts, as well as other versions with corresponding changes incorporated to the circuits to utilize them in an effectively similar manner to those presented herein.

### High Dynamic Range Reading

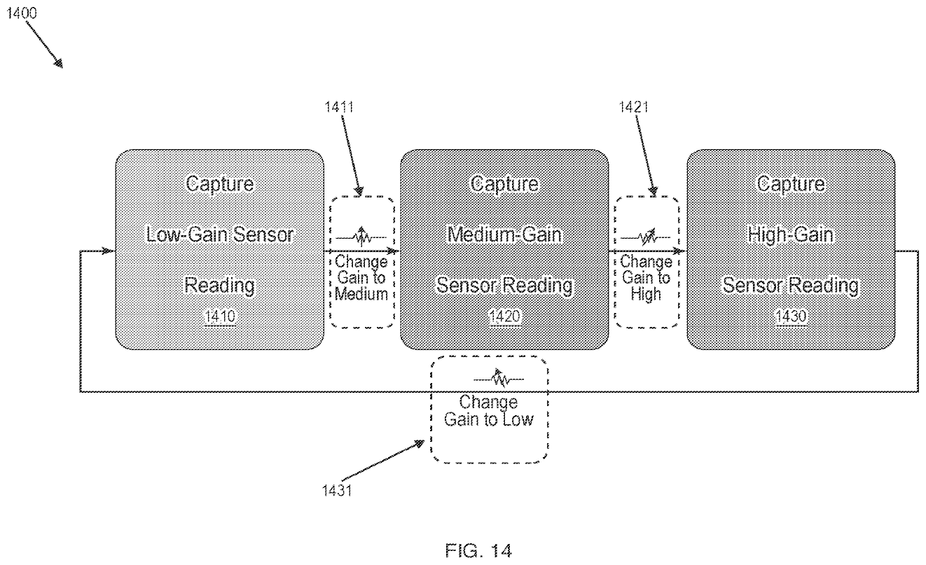

Examples of the present disclosure include a method for fusing high-dynamic range (HDR) readings from several different tactile sensor arrays. The method can take, as input, tactile readings from different (e.g., sensitivity) saturation tactile sensor arrays to recover a high-dynamic-range tactile map. As shown in FIG. 14, to capture multiple readings with different sensitivities, three consecutive sensor readings can be captured while changing the gain (e.g., potentiometer resistances) between each reading. The example routine 1400 of FIG. 14 includes capturing 1410 a low-gain sensor reading, adjusting 1411 the gain to medium, capturing 1420 a medium-gain sensor reading, adjusting 1421 the gain to high, capturing 1430 a high-gain sensor reading, and adjusting 1431 the sensor gain back to low. While FIG. 14 shows the use of three different gain settings (and three corresponding sensor readings, one at each gain), other variations are possible. For example, using two, or four or more gain settings, as well as using one, or two or more readings at each gain level, including using different numbers of readings at each gain level. Various HDR method can be used for recovering the high dynamic range tactile map, such as the Debevec HDR method. The Debevec method was originally proposed for reconstructing high dynamic range radiance maps from photographs taken with conventional imaging equipment and can take, as input, several photographs with different exposures to compute the imaging response function. With a computed response function, HDR algorithms can use a weighted objective to fuse the input photographs together to form one high-dynamic-range image.

Directly employing an HDR algorithm, such as the Debevec algorithm, to reconstruct an HDR tactile map can be difficult. First, computing a response curve on tactile reading can be computationally expensive as the tactile readings can be higher-resolution (e.g., in 14-bit), which is much more fine-grained compared to traditional 8-bit digital image data. Additionally, it can be unclear whether the linear weighting objective proposed in by original Debevec algorithm suits the task and purpose of improving the dynamic measuring range of tactile sensor maps. To solve the first problem, an HDR fusion step can be conducted after calibration. Because the force magnitude and voltage gain can differ per pixel, fitting the original response curve may be infeasible, thus HDR algorithm examples can work directly with force values and avoid response curve computation by applying HDR fusion after calibration. To encourage fast computation, Local bin values per frame can be used encourage fast computation (e.g., instead of all 14-bit across all frames), and HDR fusion can be conducted per frame and then synchronized across frames. With respect to the linear weighting objective, various commonly employed weighting schemes can be used, for example a skewed-linear weighting scheme. Implementations of multi-sampling HDR techniques to force-sensing arrays enables sensing capabilities over a wider range of forces.

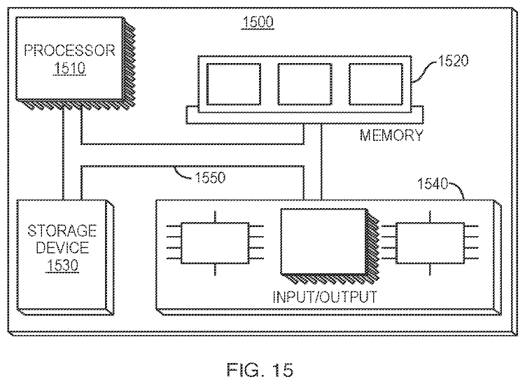

FIG. 15 provides for one non-limiting example of a computer system 1500 upon which actions provided for in the present disclosure, including but not limited to generating manufacturing instructions, can be built, performed, trained, etc. The system 1500 can include a processor 1510, a memory 1520, a storage device 1530, and an input/output device 1540. Each of the components 1510, 1520, 1530, and 1540 can be interconnected, for example, using a system bus 1550. The processor 1510 can be capable of processing instructions for execution within the system 1500. The processor 1510 can be a single-threaded processor, a multi-threaded processor, or similar device. The processor 1510 can be capable of processing instructions stored in the memory 1520 or on the storage device 1530. The processor 1510 may execute operations such as generating manufacturing instructions, among other features described in conjunction with the present disclosure.

The memory 1520 can store information within the system 1500. In some implementations, the memory 1520 can be a computer-readable medium. The memory 1520 can, for example, be a volatile memory unit or a non-volatile memory unit. In some implementations, the memory 1520 can store information related to the instructions for manufacturing sensing arrays, among other information.

The storage device 1530 can be capable of providing mass storage for the system 1500. In some implementations, the storage device 1030 can be a non-transitory computer-readable medium. The storage device 1530 can include, for example, a hard disk device, an optical disk device, a solid-date drive, a flash drive, magnetic tape, or some other large capacity storage device. The storage device 1530 may alternatively be a cloud storage device, e.g., a logical storage device including multiple physical storage devices distributed on a network and accessed using a network. In some implementations, the information stored on the memory 1520 can also or instead be stored on the storage device 1530.

The input/output device 1540 can provide input/output operations for the system 1500. In some implementations, the input/output device 1540 can include one or more of network interface devices (e.g., an Ethernet card), a serial communication device (e.g., an RS-232 10 port), and/or a wireless interface device (e.g., a short-range wireless communication device, an 802.11 card, a 3G wireless modem, or a 4G wireless modem). In some implementations, the input/output device 1540 can include driver devices configured to receive input data and send output data to other input/output devices, e.g., a keyboard, a printer, and display devices (such as the GUI 12). In some implementations, mobile computing devices, mobile communication devices, and other devices can be used.

In some implementations, the system 1500 can be a microcontroller. A microcontroller is a device that contains multiple elements of a computer system in a single electronics package. For example, the single electronics package could contain the processor 1510, the memory 1520, the storage device 1530, and input/output devices 1540.

Although an example processing system has been described above, implementations of the subject matter and the functional operations described above can be implemented in other types of digital electronic circuitry, or in computer software, firmware, and/or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible program carrier, for example a computer-readable medium, for execution by, or to control the operation of, a processing system. The computer readable medium can be a machine-readable storage device, a machine-readable storage substrate, a memory device, a composition of matter effecting a machine readable propagated signal, or a combination of one or more of them.

Various embodiments of the present disclosure may be implemented at least in part in any conventional computer programming language. For example, some embodiments may be implemented in a procedural programming language (e.g., “C”), or in an object-oriented programming language (e.g., “C++”). Other embodiments of the invention may be implemented as a pre-configured, stand-along hardware element and/or as preprogrammed hardware elements (e.g., application specific integrated circuits, FPGAs, and digital signal processors), or other related components.

The term “computer system” may encompass all apparatus, devices, and machines for processing data, including by way of example a programmable processor, a computer, or multiple processors or computers. A processing system can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, executable logic, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Such implementation may include a series of computer instructions fixed either on a tangible, non-transitory medium, such as a computer readable medium. The series of computer instructions can embody all or part of the functionality previously described herein with respect to the system. Computer readable media suitable for storing computer program instructions and data include all forms of non-volatile or volatile memory, media and memory devices, including by way of example semiconductor memory devices, e.g., EPROM, EEPROM, and flash memory devices; magnetic disks, e.g., internal hard disks or removable disks or magnetic tapes; magneto optical disks; and CD-ROM and DVD-ROM disks. The processor and the memory can be supplemented by, or incorporated in, special purpose logic circuitry. The components of the system can be interconnected by any form or medium of digital data communication, e.g., a communication network. Examples of communication networks include a local area network (“LAN”) and a wide area network (“WAN”), e.g., the Internet.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). In fact, some embodiments may be implemented in a software-as-a-service model (“SAAS”) or cloud computing model. Of course, some embodiments of the present disclosure may be implemented as a combination of both software (e.g., a computer program product) and hardware. Still other embodiments of the present disclosure are implemented as entirely hardware, or entirely software.

Some non-limiting example are provided below.

1. A resistive sensing array, comprising:
a resistive sheet having opposed first and second sides;
a first array of electrodes disposed on the first side of the resistive sheet;
a second array of electrodes disposed on the second side of the resistive sheet; and
at least one passive thread that couples the first array of electrodes to the resistive sheet and couples the second array of electrodes to the resistive sheet, the at least one electrically conductive thread being in contact with each of the first and second arrays of electrodes and passing through the resistive sheet,
wherein the first array of electrodes serve as an electrically conductive thread that is a top thread used to couple the first array of electrodes to the resistive sheet while the at least one passive thread serves as a bottom thread used to couple the first array of electrodes to the resistive sheet, and
wherein the second array of electrodes serve as an electrically conductive thread that is a bottom thread used to couple the second array of electrodes to the resistive sheet while the at least one passive thread serves a top thread used to couple the second array of electrodes to the resistive sheet.
   2. The resistive sensing array of example 1, further comprising a non-conductive film disposed above at least one of the first and second arrays of electrodes.
   3. The resistive sensing array of any of the examples herein, wherein the first array of electrodes and the second array of electrodes have a resistance lower than about 1000 ohms per meter.
   4. The resistive sensing array of any of the examples herein, wherein the at least one passive thread has a resistivity less than or equal to a resistivity of the resistive sheet.
   5. The resistive sensing array of any of the examples herein, wherein at least one of the first array of electrodes or the second array of electrodes further comprise an electrically conductive thread separate and apart from electrodes of the respective first array of electrodes or electrodes of the second array of electrodes.
   6. A method of manufacturing a resistive sensing array, comprising:
cutting an outline shape of a sensor and one or more internal voids into a resistive sheet; and
implementing a plurality of lockstitches to couple a first array of electrodes to a first side of the resistive sheet and a second array of electrodes to a second side of the resistive sheet, the first and second sides of the resistive sheet being opposed to each other.
   7. The method of any of the examples herein, wherein cutting an outline shape of a sensor and one or more internal voids into a resistive sheet provides a resulting shape that includes one or more tabs.
   8. The method of any of the examples herein, wherein the action of cutting is an automated process.
   9. The method of any of the examples herein, wherein implementing a plurality of lockstitches further comprises:
stitching the first array of electrodes through the resistive sheet such that the first array of electrodes forms a top thread that couples the first array of electrodes to the resistive sheet;
stitching a passive thread through the resistive sheet such that the passive thread forms a bottom thread that couples the first array of electrodes to the resistive sheet;
stitching the second array of electrodes through the resistive sheet such that the second array of electrodes forms a bottom thread that couples the second array of electrodes to the resistive sheet; and
stitching at least one of the passive thread or a second passive thread through the resistive sheet such that the at least one of the passive thread or a second passive thread forms a top thread that couples the second array of electrodes to the resistive sheet.
   10. The method of any of the examples herein, wherein implementing a plurality of lockstitches further comprises placing electrodes from the first array of electrodes and electrodes from the second array of electrodes in successive order.
   11. The method of any of the examples herein, wherein the action of implementing a plurality of lockstitches is performed using at least one of one or more sewing machines or one or more embroidery machines.
   12. The method of any of the examples herein, wherein the at least one of one or more sewing machines or one or more embroidery machines are automated.
   13. The method of any of the examples herein, further comprising installing an electrical connector in electrical communication with at least one of the first array of electrodes or the second array of electrodes.
   14. The method of any of the examples herein, wherein installing an electrical connector further comprises:
coupling a backing plate to at least one of the first array of electrodes or the second array of electrodes such that the at least one of the first array of electrodes or the second array of electrodes is disposed between the resistive sheet and the backing plate.
   15. The method of any of the examples herein, further comprising:
applying a protective insulating coating to the resistive sensing array formed by the resistive sheet, the first array of electrodes, and the second array of electrodes.
   16. The method of any of any of the examples herein, further comprising:
coupling the resistive sensing array formed by the resistive sheet, the first array of electrodes, and the second array of electrodes to one or more additional resistive sensing arrays.
   17. A force translator system, comprising:
a resistive sheet having opposed first and second sides;
a first array of electrodes disposed on the first side of the resistive sheet;
a second array of electrodes disposed on the second side of the resistive sheet;
one or more groups of force sensors, each group comprising three or more force sensors and each sensor formed by an intersection of an electrode of the first array and an electrode of the second array; and
a plurality of rigid blocks, each rigid block defining a bottom side mechanically coupled with one group of the one or more groups of force sensors and a top side configured to receive a force and direct the force to the one group of sensors,
wherein the each rigid block and corresponding one group of force sensors are configured to enable reconstruction of a 3D vector of force applied to the top side of the rigid block based on the force readings from the three or more force sensors mechanically coupled with the rigid block.
   18. The force translator system of any of the examples herein, wherein each force sensor of the one or more groups of force sensors are configured to measure force normal to the resistive sheet.
   19. A method of constructing a high-dynamic range tactile sensor map, the method comprising:
reading a first signal at a first gain setting for each of a plurality of resistive force sensors of a tactile sensing array;
changing the first gain setting to a second gain setting;
reading a second signal at the second gain setting for each of the plurality of resistive force sensors of the tactile sensing array; and
combining the first and second signals to generate a map of the tactile sensing array, the map comprising a single value for each of the plurality of resistive force sensors of a tactile sensing array, the single value being based on a value of the first and second signal for each the plurality of resistive force sensors with respect to a calibration curve such that the single value defines an accuracy at least as high as the highest of the first and second signals.
   20. The method of any of the examples herein, wherein the calibration curve defines an accuracy of a value of each resistive force sensors at least with respect to a magnitude of the first and second signal.
   21. A resistive sensing array, comprising:
a resistive sheet having opposed first and second sides;
a first array of electrodes disposed on the first side of the resistive sheet;
a second array of electrodes disposed on the second side of the resistive sheet; and
at least one passive thread that couples the first array of electrodes to the resistive sheet and couples the second array of electrodes to the resistive sheet, the at least one electrically conductive thread being in contact with each of the first and second arrays of electrodes and passing through the resistive sheet,
wherein the first array of electrodes serve as an electrically conductive thread that is a top thread used to couple the first array of electrodes to the resistive sheet while the at least one passive thread serves as a bottom thread used to couple the first array of electrodes to the resistive sheet, and
wherein the second array of electrodes serve as an electrically conductive thread that is a bottom thread used to couple the second array of electrodes to the resistive sheet while the at least one passive thread serves a top thread used to couple the second array of electrodes to the resistive sheet.
   22. The resistive sensing array of any of the examples herein, further comprising a non-conductive film disposed above at least one of the first and second arrays of electrodes.
   23. The resistive sensing array of any of the examples herein, wherein the first array of electrodes and the second array of electrodes have a resistance lower than about 1000 ohms per meter.
   24. The resistive sensing array of any of the examples herein, wherein the at least one passive thread has a resistivity less than or equal to a resistivity of the resistive sheet.
   25. The resistive sensing array of any of the examples herein, wherein at least one of the first array of electrodes or the second array of electrodes further comprise an electrically conductive thread separate and apart from electrodes of the respective first array of electrodes or electrodes of the second array of electrodes.
   26. A method of manufacturing a resistive sensing array, comprising:
cutting an outline shape of a sensor and one or more internal voids into a resistive sheet; and
implementing a plurality of lockstitches to couple a first array of electrodes to a first side of the resistive sheet and a second array of electrodes to a second side of the resistive sheet, the first and second sides of the resistive sheet being opposed to each other.
   27. The method of any of the examples herein, wherein cutting an outline shape of a sensor and one or more internal voids into a resistive sheet provides a resulting shape that includes one or more tabs.
   28. The method of any of the examples herein, wherein the action of cutting is an automated process.
   29. The method of any of the examples herein, wherein implementing a plurality of lockstitches further comprises:
stitching the first array of electrodes through the resistive sheet such that the first array of electrodes forms a top thread that couples the first array of electrodes to the resistive sheet;
stitching a passive thread through the resistive sheet such that the passive thread forms a bottom thread that couples the first array of electrodes to the resistive sheet;
stitching the second array of electrodes through the resistive sheet such that the second array of electrodes forms a bottom thread that couples the second array of electrodes to the resistive sheet; and
stitching at least one of the passive thread or a second passive thread through the resistive sheet such that the at least one of the passive thread or a second passive thread forms a top thread that couples the second array of electrodes to the resistive sheet.
   30. The method of any of any of the examples herein, wherein implementing a plurality of lockstitches further comprises placing electrodes from the first array of electrodes and electrodes from the second array of electrodes in successive order.
   31. The method of any of the examples herein, wherein the action of implementing a plurality of lockstitches is performed using at least one of one or more sewing machines or one or more embroidery machines.
   32. The method of any of the examples herein, wherein the at least one of one or more sewing machines or one or more embroidery machines are automated.
   33. The method of any of the examples herein, further comprising installing an electrical connector in electrical communication with at least one of the first array of electrodes or the second array of electrodes.
   34. The method of any of the examples herein, wherein installing an electrical connector further comprises:
coupling a backing plate to at least one of the first array of electrodes or the second array of electrodes such that the at least one of the first array of electrodes or the second array of electrodes is disposed between the resistive sheet and the backing plate.
   35. The method of any of the examples herein, further comprising:
applying a protective insulating coating to the resistive sensing array formed by the resistive sheet, the first array of electrodes, and the second array of electrodes.
   36. The method of any of the examples herein, further comprising:
coupling the resistive sensing array formed by the resistive sheet, the first array of electrodes, and the second array of electrodes to one or more additional resistive sensing arrays.
   37. The method of any of the examples herein, wherein the one or more additional resistive sensing arrays are manufactured using the methods of the examples herein.
   38. A resistive sensing array formed using the methods of any of the examples herein.
   39. A method of manufacturing any of the resistive sensing arrays of any of the examples herein.

One skilled in the art will appreciate further features and advantages of the disclosures based on the provided for descriptions and embodiments. Accordingly, the inventions are not to be limited by what has been particularly shown and described. All publications and references cited herein are expressly incorporated by reference in their entirety.

1. A resistive sensing array, comprising:
a resistive sheet having opposed first and second sides;
a first array of electrodes disposed on the first side of the resistive sheet;
a second array of electrodes disposed on the second side of the resistive sheet; and
at least one passive thread that couples the first array of electrodes to the resistive sheet and couples the second array of electrodes to the resistive sheet, the at least one electrically conductive thread being in contact with each of the first and second arrays of electrodes and passing through the resistive sheet,
wherein the first array of electrodes serve as an electrically conductive thread that is a top thread used to couple the first array of electrodes to the resistive sheet while the at least one passive thread serves as a bottom thread used to couple the first array of electrodes to the resistive sheet, and
wherein the second array of electrodes serve as an electrically conductive thread that is a bottom thread used to couple the second array of electrodes to the resistive sheet while the at least one passive thread serves a top thread used to couple the second array of electrodes to the resistive sheet.

2. The resistive sensing array of claim 1, further comprising a non-conductive film disposed above at least one of the first and second arrays of electrodes.

3. The resistive sensing array of claim 1, wherein the first array of electrodes and the second array of electrodes have a resistance lower than about 1000 ohms per meter.

4. The resistive sensing array of claim 1, wherein the at least one passive thread has a resistivity less than or equal to a resistivity of the resistive sheet.

5. The resistive sensing array of claim 1, wherein at least one of the first array of electrodes or the second array of electrodes further comprise an electrically conductive thread separate and apart from electrodes of the respective first array of electrodes or electrodes of the second array of electrodes.

6. A method of manufacturing a resistive sensing array, comprising:
cutting an outline shape of a sensor and one or more internal voids into a resistive sheet; and
implementing a plurality of lockstitches to couple a first array of electrodes to a first side of the resistive sheet and a second array of electrodes to a second side of the resistive sheet, the first and second sides of the resistive sheet being opposed to each other.

7. The method of claim 6, wherein cutting an outline shape of a sensor and one or more internal voids into a resistive sheet provides a resulting shape that includes one or more tabs.

8. The method of claim 6, wherein the action of cutting is an automated process.

9. The method of claim 6, wherein implementing a plurality of lockstitches further comprises:
stitching the first array of electrodes through the resistive sheet such that the first array of electrodes forms a top thread that couples the first array of electrodes to the resistive sheet;
stitching a passive thread through the resistive sheet such that the passive thread forms a bottom thread that couples the first array of electrodes to the resistive sheet;
stitching the second array of electrodes through the resistive sheet such that the second array of electrodes forms a bottom thread that couples the second array of electrodes to the resistive sheet; and
stitching at least one of the passive thread or a second passive thread through the resistive sheet such that the at least one of the passive thread or a second passive thread forms a top thread that couples the second array of electrodes to the resistive sheet.

10. The method of claim 6, wherein implementing a plurality of lockstitches further comprises placing electrodes from the first array of electrodes and electrodes from the second array of electrodes in successive order.

11. The method of claim 6, wherein the action of implementing a plurality of lockstitches is performed using at least one of one or more sewing machines or one or more embroidery machines.

12. The method of claim 11, wherein the at least one of one or more sewing machines or one or more embroidery machines are automated.

13. The method of claim 6, further comprising installing an electrical connector in electrical communication with at least one of the first array of electrodes or the second array of electrodes.

14. The method of claim 13, wherein installing an electrical connector further comprises:
coupling a backing plate to at least one of the first array of electrodes or the second array of electrodes such that the at least one of the first array of electrodes or the second array of electrodes is disposed between the resistive sheet and the backing plate.

15. The method of claim 6, further comprising:
applying a protective insulating coating to the resistive sensing array formed by the resistive sheet, the first array of electrodes, and the second array of electrodes.

16. The method of any of claim 6, further comprising:
coupling the resistive sensing array formed by the resistive sheet, the first array of electrodes, and the second array of electrodes to one or more additional resistive sensing arrays.

17. A force translator system, comprising:
a resistive sheet having opposed first and second sides;
a first array of electrodes disposed on the first side of the resistive sheet;
a second array of electrodes disposed on the second side of the resistive sheet;
one or more groups of force sensors, each group comprising three or more force sensors and each sensor formed by an intersection of an electrode of the first array and an electrode of the second array; and
a plurality of rigid blocks, each rigid block defining a bottom side mechanically coupled with one group of the one or more groups of force sensors and a top side configured to receive a force and direct the force to the one group of sensors,
wherein the each rigid block and corresponding one group of force sensors are configured to enable reconstruction of a 3D vector of force applied to the top side of the rigid block based on the force readings from the three or more force sensors mechanically coupled with the rigid block.

18. The force translator system of claim 17, wherein each force sensor of the one or more groups of force sensors are configured to measure force normal to the resistive sheet.

19-20. (canceled)
